(19) United States
(12) Patent Application Publication
(10) Pub. No.: US 2026/0160701 A1
(43) Pub. Date: Jun. 11, 2026

(54) DEVICE FOR DIAGNOSING INSPECTION APPARATUS, METHOD FOR DIAGNOSING INSPECTION APPARATUS, AND PROGRAM

(71) Applicants: KABUSHIKI KAISHA N-TECH, Gifu-ken (JP); KABUSHIKI KAISHA YAKULT HONSHA, Tokyo (JP); TOHOSHOJI KABUSHIKI KAISHA, Osaka-shi, Osaka (JP)

(72) Inventors: Motoki UNO, Gifu-ken (JP); Tohru WATANABE, Gifu-ken (JP); Yu YOSHIDA, Tokyo (JP); Kunio KOMATSU, Tokyo (JP); Kunimitsu TOYOSHIMA, Osaka-shi (JP)

(21) Appl. No.: 19/129,109

(22) PCT Filed: Nov. 10, 2023
(86) PCT No.: PCT/JP2023/040513

§ 371 Date: May 12, 2025

(30) Foreign Application Priority Data
Nov. 15, 2022 (JP) 2022-182759

(51) Int. Cl. G01N 21/88; G06V 10/74

(52) U.S. Cl. CPC G01N 21/8851; G06V 10/761

(57) ABSTRACT

A diagnosing device includes an information acquisition unit, a storage unit, a determination unit, and a diagnosis processing unit. The information acquisition unit acquires actual configuration data and an actual inspection image as actual information from an inspection apparatus. The storage unit stores standard configuration data and a reference image as reference information. The determination unit performs individual comparisons for each of multiple pairs of the actual information and the reference information, including a first comparison between the actual configuration data and the standard configuration data, and a second comparison between the actual inspection image and the reference image, to determine whether there is a difference in each comparison pair of the same type. The diagnosis processing unit analyzes a factor of the difference and then performs diagnosis of the inspection apparatus (20) with diagnosis content according to the analysis result.

### TECHNICAL FIELD

The present invention relates to a device for diagnosing an inspection apparatus, a method for diagnosing an inspection apparatus, and a program.

### BACKGROUND ART

Patent Literatures 1 to 3 disclose techniques for simulating inspection of an inspection object performed by an inspection apparatus. For example, Patent Literature 1 discloses a configuration support system in which a cloud system edits configuration data in response to operations from a PC. The cloud system simulates an image inspection performed by an image processing device using the edited configuration data and a workpiece image. The cloud system then transmits the inspection result based on pre-edition configuration data and the simulation result based on the edited configuration data to the PC.

Patent Literature 2 discloses an image processing system for an inspection apparatus that sets appropriate configuration data by simulating inspection of an inspection object performed by the inspection apparatus. Patent Literature 3 discloses an appearance inspection apparatus that simulates determination of whether an inspection object is non-defective or defective based on a second inspection condition different from a first inspection condition used by an inspection apparatus.

A typical inspection apparatus performs an inspection test (simulation) using, as reference images for testing purposes, images of non-defective and defective articles to ensure that the inspection of an inspection object is conducted, so that the inspection object is determined to be non-defective or defective with a required accuracy. During this test, the configuration data is reviewed and adjusted until the required accuracy is achieved. As a result, the configuration data is set to enable inspection to be conducted correctly with the required accuracy.

### CITATION LIST

### Patent Literature

Patent Literature 1: Japanese Laid-Open Patent Publication No. 2019-95983

Patent Literature 2: Japanese Laid-Open Patent Publication No. 2010-102736

Patent Literature 3: Japanese Laid-Open Patent Publication No. 2011-47698

### SUMMARY OF INVENTION

### Technical Problem

However, in an inspection apparatus, even if tests are conducted during startup or when switching articles to set configuration data that ensures the required accuracy, inspections may no longer achieve the required accuracy over time. For example, if any condition in the configuration data changes, such as variations in factory lighting (ambient light), degradation of the inspection lighting unit, deterioration of the camera, changes in the camera's image capturing condition, or modifications to the image processing condition for inspection images, the required inspection accuracy may no longer be achieved. Environmental changes within the factory or failure to update the inspection application (software) may also result in a loss of the required inspection accuracy.

In such cases, an operator adjusts the configuration data. However, inappropriate adjustments of the configuration data may occur.

Furthermore, even if the configuration data is correct, reference images for testing purposes may be inappropriate. Tests are conducted using images of non-defective and defective articles as reference images to properly adjust the configuration data. However, when deterioration of the lighting unit or camera, environmental changes, or the like occur, the reference images originally used to set the configuration data may become inappropriate. In such cases, even if the configuration data is readjusted using the reference images for testing purposes, the resulting configuration may still be inappropriate.

If the configuration data is obviously inappropriate, abnormalities, such as non-defective articles being misclassified as defective, may be detected relatively quickly. However, if the configuration data contains inspection conditions deviating only slightly from the optimal conditions, it may be difficult to detect that inspections are being performed with insufficient accuracy. A delay in detecting improper inspections can lead to decreased product yield and reduced productivity. Accordingly, there is a need for a device for diagnosing an inspection apparatus that promptly detects inspections being conducted under inappropriate inspection conditions.

### Solution to Problem

Means and operational advantages for achieving the above objective will be described below.

To achieve the foregoing objectives, a diagnosing device for an inspection apparatus diagnoses the inspection apparatus based on actual information acquired from the inspection apparatus. The diagnosing device includes an information acquisition unit that acquires, as the actual information, actual configuration data and an actual inspection image from the inspection apparatus, a storage unit that stores, as reference information, standard configuration data and a reference image, a determination unit, and a diagnosis processing unit. The determination unit performs individual comparisons for each of multiple pairs of the actual information and the reference information, including a first comparison between the actual configuration data and the standard configuration data, and a second comparison between the actual inspection image and the reference image, to determine whether there is a difference in each comparison pair of a same type. The diagnosis processing unit performs factor analysis for analyzing a factor of the difference according to a combination regarding whether there is the difference in each of the pairs acquired as a determination result. The diagnosis processing unit performs diagnosis of the inspection apparatus with diagnosis content according to an obtained factor analysis result.

With this configuration, it is possible to diagnose whether the inspection apparatus is performing inspections properly. For example, inappropriate inspection conditions are detected at an early stage and reported, allowing for more frequent optimization of the inspection conditions.

In the above-described diagnosing device for the inspection apparatus, when the determination result of the determination unit indicates that there is no difference in the first comparison and there is a difference in the second comparison, the diagnosis processing unit may perform diagnosis for analyzing an image difference factor. When an image difference is within an allowable range, the diagnosis processing unit may generate a new reference image by modifying the reference image based on a difference analysis result, and perform an inspection accuracy test using the actual configuration data and the new reference image. When an accuracy result is insufficient, the diagnosis processing unit may generate new configuration data for improving inspection accuracy.

With this configuration, if the inspection apparatus is unable to perform inspections with the required accuracy due to inspection images, new configuration data that improves the inspection accuracy is provided.

In the above-described diagnosing device for the inspection apparatus, when the determination result of the determination unit indicates that there is a difference in the first comparison and there is no difference in the second comparison, the diagnosis processing unit may perform diagnosis for analyzing a configuration data difference factor. When a configuration data difference is within an allowable range, the diagnosis processing unit may perform an inspection accuracy test using the actual configuration data and the reference image based on a difference analysis result. When an accuracy result is insufficient, the diagnosis processing unit may generate new configuration data for improving inspection accuracy.

With this configuration, if the inspection apparatus is unable to perform inspections with the required accuracy due to configuration data, new configuration data that improves the inspection accuracy is provided.

In the above-described diagnosing device for the inspection apparatus, when the determination result of the determination unit indicates that there is a difference in the first comparison and there is a difference in the second comparison, the diagnosis processing unit may perform diagnosis for analyzing an image difference factor. When an image difference is within an allowable range, the diagnosis processing unit may perform diagnosis for analyzing a configuration data difference factor. When a configuration data difference is within an allowable range, the diagnosis processing unit may generate a new reference image by modifying the reference image based on an image difference analysis result, and performs an inspection accuracy test using the actual configuration data and the new reference image. When an accuracy result is insufficient, the diagnosis processing unit may generate new configuration data for improving inspection accuracy.

With this configuration, if the inspection apparatus is unable to perform inspections with the required accuracy due to configuration data and inspection images, new configuration data that improves the inspection accuracy is provided.

The above-described diagnosing device for the inspection apparatus may include an output unit that outputs data and an input unit that receives instructions. The diagnosis processing unit may output the new configuration data to the output unit. When receiving an instruction to adopt the new configuration data from the input unit, the diagnosis processing unit may update the standard configuration data and the reference image based on the new configuration data.

With this configuration, the standard configuration data and the reference image is updated based on the adopted new configuration data, enabling the inspection apparatus to perform subsequent inspections properly.

The above-described diagnosing device for the inspection apparatus may store, in the storage unit, the standard configuration data and the reference image before the standard configuration data and the reference image are updated based on the new configuration data. The diagnosing device may store, in the storage unit, a difference between pre-update data and updated new data for at least one of the standard configuration data and the reference image that has been updated.

With this configuration, the history of the diagnosing device can be checked by retrieving, from the storage unit, at least one of the pre-update standard configuration data, the pre-update reference image, and the difference between the pre-update data and the updated data. For example, the history information can be used for recovery or analysis and can further serve to restrict the escalation of a difference in the configuration data and the reference images among multiple identical inspection apparatuses.

The above-described diagnosing device for the inspection apparatus may acquire an actual inspection result as the actual information from the inspection apparatus. When the determination result of the determination unit indicates that there is no difference in the first comparison and there is no difference in the second comparison, the diagnosis processing unit may perform a virtual inspection using the actual configuration data and the actual inspection image, and performs a comparison diagnosis between a virtual inspection result and the actual inspection result.

With this configuration, when there is a difference between the virtual inspection result and the actual inspection result even though neither the configuration data nor the inspection image is the cause, it is possible to diagnose whether the inspection process is improper. For example, it is possible to diagnose that the version of the inspection processing software is inappropriate.

The above-described diagnosing device for the inspection apparatus may include a server connected to the inspection apparatus and a terminal via a network. The server may include the information acquisition unit, the storage unit, the determination unit, and the diagnosis processing unit. The server may acquire the actual configuration data and the actual inspection image from the inspection apparatus. The server may transmit a diagnostic result of the diagnosis processing unit to the terminal.

With this configuration, the diagnosis of the inspection apparatus can be performed via the network, and the diagnostic result can be checked on the terminal via the network. The server may be an in-house server, a manufacturer-provided dedicated diagnosing server, or a cloud server.

To achieve the foregoing objectives, a diagnosing method for an inspection apparatus includes diagnosing the inspection apparatus based on actual information acquired from the inspection apparatus. The diagnosing method includes: an information acquisition step in which an information acquisition unit acquires actual configuration data and an actual inspection image as the actual information from the inspection apparatus; a determination step in which a determination unit performs individual comparisons for each of multiple pairs of the actual information and reference information, including a first comparison between the actual configuration data and standard configuration data, and a second comparison between the actual inspection image and a reference image, to determine whether there is a difference in each comparison pair of a same type; and a diagnosis processing step in which a diagnosis processing unit performs diagnosis with diagnosis content according to a combination regarding whether there is the difference in each of the pairs acquired as a determination result.

With this method, it is possible to diagnose whether the inspection apparatus is performing inspections properly.

To achieve the foregoing objectives, a program causes a computer to execute a process of diagnosing an inspection apparatus based on actual information acquired from the inspection apparatus. The program causes the computer to execute: an information acquisition step that acquires actual configuration data and an actual inspection image as the actual information from the inspection apparatus; a determination step that performs individual comparisons for each of multiple pairs of the actual information and reference information, including a first comparison between the actual configuration data and standard configuration data, and a second comparison between the actual inspection image and a reference image, to determine whether there is a difference in each comparison pair of a same type; and a diagnosis processing step that performs diagnosis with diagnosis content according to a combination regarding whether there is the difference in each of the pairs acquired as a determination result.

With this configuration, by executing the program on the computer, it is possible to diagnose whether the inspection apparatus is performing inspections correctly.

### Advantageous Effects of Invention

With the present invention, it is possible to diagnose whether the inspection apparatus is performing inspections correctly.

### BRIEF DESCRIPTION OF DRAWINGS

FIG. 1 is a schematic diagram showing an inspection system according to an embodiment.

FIG. 2 is a schematic diagram showing an inspection apparatus.

FIG. 3 is a schematic diagram showing reference images stored in a storage unit.

FIG. 4 is a schematic diagram for explaining an inspection process.

FIG. 5 is a schematic diagram for explaining an inspection process for extracting defects.

FIG. 6 is a block diagram showing an electrical configuration of the inspection system.

FIG. 7 is a schematic diagram showing data, programs, and the like stored in a second storage unit.

FIG. 8 is a diagram showing a determination table.

FIG. 9 is a flowchart showing a diagnosis main routine.

FIG. 10 is a flowchart showing an updating process.

FIG. 11 is a flowchart showing a diagnostic process routine.

### DESCRIPTION OF EMBODIMENTS

An imaging device will now be described with reference to the drawings.

### Schematic Configuration of Inspection System 10

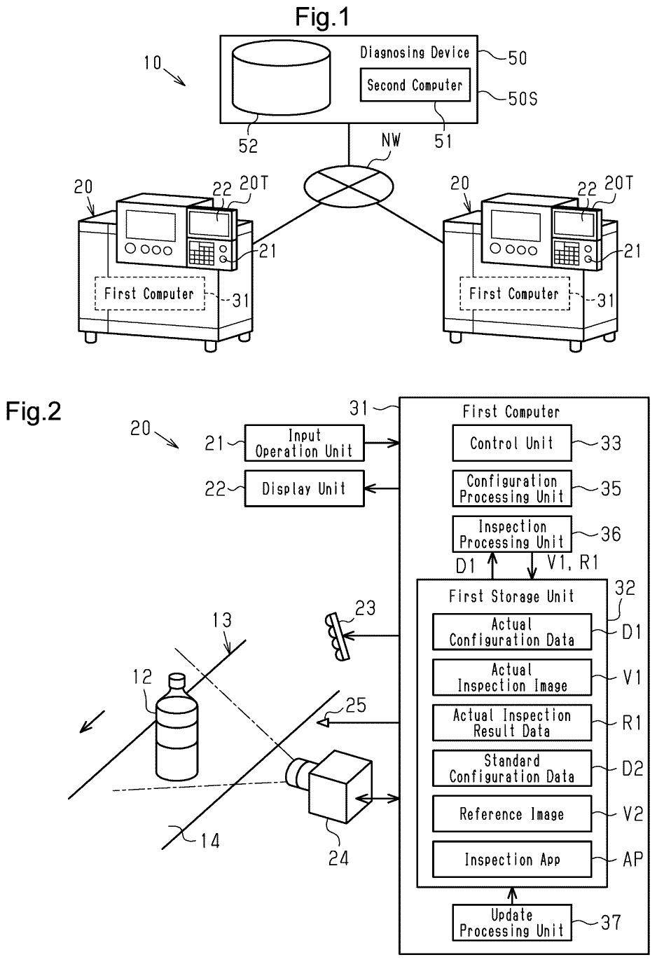

FIG. 1 shows an inspection system 10 according to the present embodiment. The inspection system 10 includes inspection apparatuses 20 and a diagnosing device 50.

The inspection apparatuses 20 inspect inspection objects. For example, multiple inspection apparatuses 20 are installed in a factory. Each inspection apparatus 20 includes a first computer 31, which performs control related to inspection. The inspection apparatus 20 also includes an input operation unit 21, which is operated by a user (operator) to give instructions to the inspection apparatus 20, and a display unit 22, which displays various menus and a configuration screen related to inspection. In the example illustrated in FIG. 1, each inspection apparatus 20 includes a terminal 20T. The terminal 20T may be personal computers installed separately from the inspection apparatus 20. In this case, the terminal 20T may be communicatively connected to multiple inspection apparatuses 20 in a shared manner. In summary, any type of device may be used as the terminal 20T as long as it that allows the user of the inspection apparatus 20 to perform operations and check displayed information.

The diagnosing device 50 diagnoses whether the inspection apparatuses 20 are performing inspections properly. In the example shown in FIG. 1, the diagnosing device 50 includes a server 50S connected to the inspection apparatuses 20 via a network NW such as the internet. The server 50S is communicatively connected to the inspection apparatuses 20 and the terminals 20T via the network NW. In this example, the server 50S is a cloud server 50S, but may be an in-house server 50S or a manufacturer-provided dedicated server 50S. In addition, the diagnosing device 50 includes a second computer 51, which controls a diagnostic process. The second computer 51 includes a second storage unit 52, which stores information necessary for diagnosis acquired from the inspection apparatuses 20. The information includes configuration data, an inspection image, a reference image for testing purposes (simulation), and an inspection application. Details of the information will be described later.

### Configuration of Inspection Apparatus 20

Next, the configuration of the inspection apparatus 20 will be described with reference to FIG. 2. FIG. 2 shows an example in which an article 12 to be inspected is a container.

As shown in FIG. 2, for example, a conveying apparatus 13 for conveying an article 12 to be inspected is installed in the factory. The article 12 is conveyed by a conveyor 14 of the conveying apparatus 13 along a path through an inspection area of the inspection apparatus 20. The inspection apparatus 20 includes a lighting unit 23 (light source), which irradiates the article 12 positioned in the inspection area with light, a camera 24, which captures images of the article 12, and a sensor 25, which detects the article 12 when the article 12 reaches the inspection area (inspection position).

When the sensor 25 detects the article 12, the inspection apparatus 20 activates the lighting unit 23 and the camera 24. As a result, the camera 24 captures an image of the article 12 irradiated with the light from the lighting unit 23. The image captured by the camera 24 is sent to the first computer 31 as an actual inspection image V1. In the inspection apparatus 20, the first computer 31 performs inspection based on the actual inspection image V1. The inspection result is output to the display unit 22. In addition, when the article 12 inspected by the inspection apparatus 20 is a defective article, a defective article signal is transmitted to a controller (not shown) of the conveyance system. The controller removes the article 12 determined to be a defective article from the conveyor 14 by activating a defective article removing mechanism (not shown) based on the defective article signal.

The first computer 31 of the inspection apparatus 20 includes a first storage unit 32. The first computer 31 includes a control unit 33, a configuration processing unit 35, and an inspection processing unit 36. The first storage unit 32 stores actual configuration data D1, the actual inspection image V1, actual inspection result data R1, standard configuration data D2, reference images V2, and an inspection application AP (hereinafter, also simply referred to as “inspection app AP”). In the present embodiment, the actual configuration data D1 and the actual inspection image V1 correspond to examples of actual information RD. The standard configuration data D2 and the reference images V2 correspond to examples of reference information SD.

The control unit 33 controls the lighting unit 23 and the camera 24 based on a detection signal from the sensor 25. The first computer 31 includes a signal processing unit (not shown), which converts an image signal acquired from the camera 24 into image data, and an image processing unit (not shown), which performs necessary processes (including image processing) on the image data.

The configuration processing unit 35 receives input values for each configuration item, which are entered by a user through the input operation unit 21 in a configuration screen (not shown) displayed on the display unit 22. Upon reception of these input values, the configuration processing unit 35 sets configuration data, which is defined by various configuration values. The inspection accuracy varies depending on the content of the configuration data. Therefore, to ensure that inspections are performed with the required accuracy, it is necessary to set appropriate configuration data. The configuration data set by the configuration processing unit 35 is stored in the first storage unit 32.

As shown in FIG. 2, the configuration information includes the actual configuration data D1, which is used for actual inspection, and the standard configuration data D2. The standard configuration data D2 is set by performing a test in which the reference images V2 for testing purposes are used to first determine the configuration information. When inspection of the article 12 is started, the standard configuration data D2, which has been determined in advance through the test, is used as the actual configuration data D1.

Thereafter, when the accuracy of inspection decreases due to various factors including deterioration of components such as the lighting unit 23 and the camera 24 and changes in the environment around or inside the inspection apparatus 20, the user adjusts the actual configuration data D1 by operating the input operation unit 21.

For example, when the installation position or the installation angle of the camera 24 is changed, the focal length or the magnification of the camera 24, and accordingly, the shutter speed or the aperture value may be changed. The user views the actual inspection image V1 captured by the camera 24 on the display unit 22, causes the display unit 22 to display a configuration screen, and operates the input operation unit 21 to adjust the actual configuration data D1. In this manner, the actual configuration data DI is changed.

The configuration data D1 and D2 include configuration values for determining the image capturing condition of the camera 24, configuration values for determining an illumination condition of the lighting unit 23, configuration values for determining an image processing condition for performing image processing on the inspection image in the inspection process, and the like. For example, the configuration values for determining the image capturing condition include a focal length, a magnification, an aperture value, a shutter speed, and a gain. The configuration values for determining the illumination condition include the quantity of light, the color of light, the light emission timing, and the light emission duration. The configuration values for determining the image processing condition include configuration values for brightness, contrast, and other image processing values (for example, a y correction value), the threshold for binarization processing, and a configuration value for edge processing. If the camera 24 is configured as a fixed-focus camera with manual aperture and focus adjustments, the configuration data D1 and D2 do not necessarily need to include configuration values related to aperture or focus.

The inspection processing unit 36 is implemented within the first computer 31 by executing the inspection app AP, which is retrieved from the first storage unit 32. The inspection processing unit 36 is implemented by software having an inspection processing function. The inspection processing unit 36 controls an inspection process in which the inspection apparatus 20 inspects the article 12. When the inspection processing unit 36 (inspection app AP) is used, the standard configuration data D2 is set for each inspection apparatus 20. The inspection app AP is upgraded regularly or irregularly. The inspection app AP is updated by, for example, downloading a new version from the server 50S.

The inspection processing unit 36 inspects the article 12 using the actual inspection image V1 captured by the camera 24. At this time, the inspection processing unit 36 uses the actual configuration data D1 retrieved from the first storage unit 32. Specifically, the inspection processing unit 36 inspects a captured image of the article 12 in the actual inspection image V1 by performing processing based on the actual configuration data D1 (including configuration values and thresholds of image processing) on the actual inspection image V1. The inspection processing unit 36 determines whether the article 12 is a non-defective article or a defective article in the inspection process. The inspection processing unit 36 outputs an inspection result obtained by determining whether the article 12 is a non-defective article or a defective article as inspection result data R1. The control unit 33 displays the inspection result data R1 on the display unit 22. When the inspection result data R1 indicates a defective article, the control unit 33 controls the defective article removing mechanism.

The first storage unit 32 stores the standard configuration data D2 and the actual configuration data D1, which have been set via the configuration processing unit 35. Further, the first storage unit 32 stores the reference images V2 for tests for checking whether the configuration content is appropriate when the standard configuration data D2 and the actual configuration data D1 are set. Furthermore, the first storage unit 32 stores the actual inspection image V1, which is captured by the camera 24 and used for actual inspections. The details of the reference images V2 will be described later.

### Reference Image V2

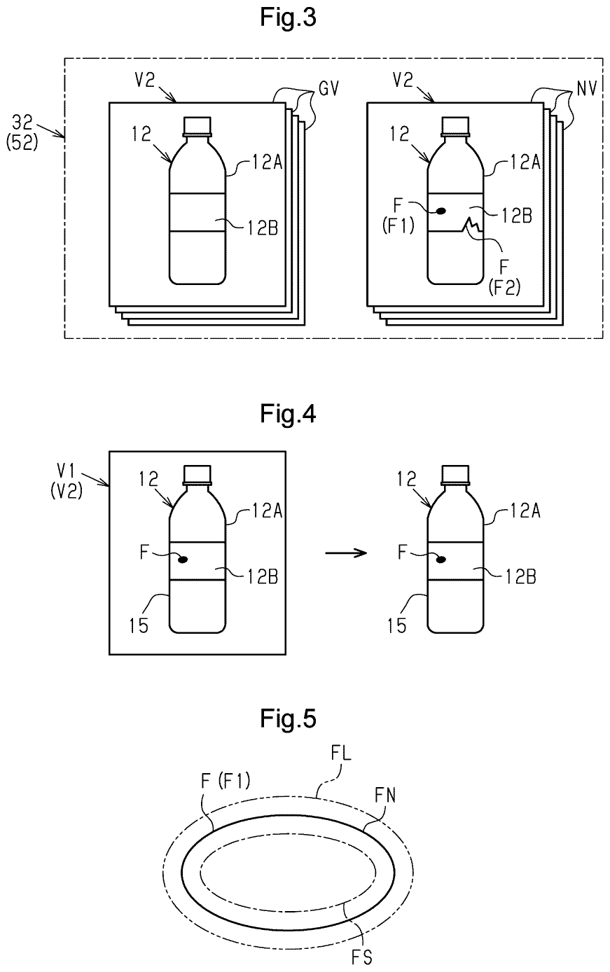

The reference image V2 for testing purposes will now be described with reference to FIG. 3. An example in which the article 12 is a container will be described. As shown in FIG. 3, when the article 12 in the reference image V2 is a container, the article 12 includes a container body 12A and a label 12B attached to the container body 12A.

The user stores the reference image V2 in the first storage unit 32 before setting the standard configuration data D2. As shown in FIG. 3, the reference images V2 include non-defective article images GV obtained by capturing images of non-defective articles 12 with the camera 24 and defective article images NV obtained by capturing images of defective articles 12 with the camera 24. The non-defective article images GV include various images to be determined as non-defective articles. The defective article images NV include various images to be determined as defective articles. The defective article images NV include defects F of the articles 12. The defects F include a stain F1, a tear F2, and the like. Other examples of defects F include misaligned printing and scratches. Additionally, the inspection processing unit 36 inspects the label 12B on the article 12 for misalignment. If the label 12B is misaligned, the article 12 is also classified as a defective article. The non-defective article images GV may include various non-defective articles in which defects F such as stains, tears, misaligned printing, and scratches are within allowable limits. Furthermore, the non-defective article images GV may also include images captured under varying illumination and image capturing conditions within an allowable range from the median value, considering potential fluctuations due to environmental changes.

The user performs a test (inspection) by providing the multiple non-defective article images GV and the multiple defective article images NV to the inspection processing unit 36 (inspection app AP). The configuration data is repeatedly adjusted until a correct inspection result is obtained with a required accuracy in all the non-defective article images GV and all the defective article images NV. The standard configuration data D2 is determined by this test. Therefore, if the inspection processing unit 36 performs the inspection process based on the standard configuration data D2, the article 12 can be inspected with necessary inspection accuracy. Accordingly, under normal circumstances, the standard configuration data D2 is used as the actual configuration data D1 until the article 12 is switched to a different model number or a different type.

However, for example, if components of the inspection apparatus 20, such as the lighting unit 23 and the camera 24, deteriorate over time, or if the installation position or orientation of the lighting unit 23 or the camera 24 is changed, or if environmental conditions within the factory change (including variations in ambient light or temperature), the conditions will differ from those during testing. Under these circumstances, even if the standard configuration data D2 is used as the actual configuration data D1, the required inspection accuracy may no longer be ensured. For example, if the required inspection accuracy is not achieved, the user operates the input operation unit 21 on the configuration screen to adjust the actual configuration data D1. However, if the adjustment of the actual configuration data D1 is inappropriate, the required inspection accuracy will not be ensured. Additionally, even if the user performs a test using the reference images V2 to reset the standard configuration data D2, the reference images V2 may become inappropriate if the conditions or environment have changed since the creation of the reference images V2. In such cases as well, the required inspection accuracy cannot be ensured.

Accordingly, in the present embodiment, the diagnosing device 50 determines whether the inspection apparatus 20 is inspecting an inspection object with the required accuracy. The diagnosing device 50 not only diagnoses the inspection apparatus 20 and provides a diagnostic result indicating whether the inspection apparatus 20 is functioning normally or abnormally, but also includes an update recommendation function. This function provides the user with new data for updating at least one of the standard configuration data D2 and the reference images V2 if the diagnostic result is not abnormal but still inappropriate. When the diagnosing device 50 performs a diagnosis, the reference images V2 required for the diagnosis are stored in the second storage unit 52.

### Inspection Content

The content of the inspection will now be described with reference to FIGS. 4 and 5. When the actual inspection image V1 shown in FIG. 4 is obtained, the inspection processing unit 36 performs edge processing and the like on the actual inspection image V1 to extract a contour line 15 of the article 12. Then, the image of the article 12 is clipped from the actual inspection image V1 along the contour line 15. Next, a defect extraction process of extracting a defect F from the clipped image of the article 12 is performed. The defect extraction process may be, for example, a binarization process in which pixel values of 0 and 1 are used to separate the defect F from non-defective regions. Alternatively, the defect extraction process may be a comparison process that compares the inspected article image with a non-defective article image (a sample image of a non-defective article) and extracts mismatched regions as defect candidates.

Through the defect extraction process, a candidate of a defect F, such as that shown in FIG. 5, is extracted. The region size of the candidate of the defect F to be extracted changes depending on the configuration value of the defect extraction process. Accordingly, depending on the configuration value, the extracted defect region may be an appropriate defect region FN that correctly represents the actual defect F, an excessively large inappropriate defect region FL, or an excessively small inappropriate defect region FS.

When an inappropriate defect region FL or FS is extracted, an article may be determined as a defective article although the article is a non-defective article, or an article may be determined as a non-defective article although the article is a defective article. In this case, it is necessary to adjust the configuration value of the defect extraction processing.

When the defect region FN shown in FIG. 5 is determined, the inspection processing unit 36 determines whether the defect candidate is a defect based on at least one parameter. The parameters are, for example, the size (for example, area) and shape of the defect region FN. As the shape, for example, an aspect ratio (the ratio of the vertical and horizontal sides) of a rectangle circumscribing the defect region FN may be used as a parameter. Further, a parameter for determining a color may be used. For example, a threshold is set for each parameter. The inspection processing unit 36 determines whether each parameter value exceeds a threshold. Then, the inspection processing unit 36 determines whether the candidate of the defect F is a defect based on the combination of the determination results of all the parameters. The test is performed in the same inspection process by the inspection processing unit 36 by using the reference images V2 instead of the actual inspection image V1 in FIG. 4.

Electrical Configurations of the Inspection Apparatus 20 and the Diagnosing Device 50

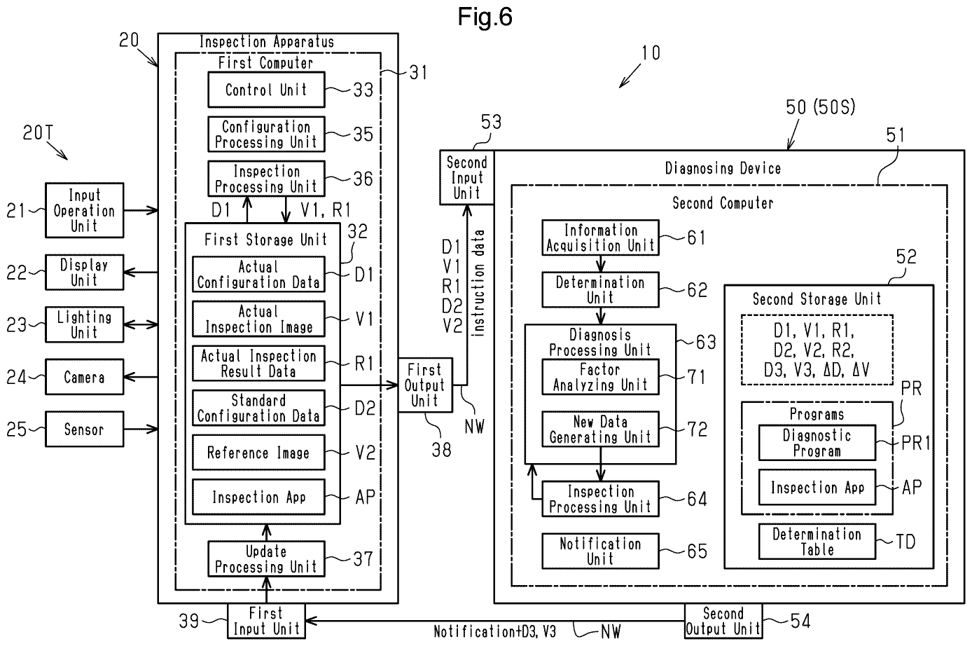

The electrical configurations of the inspection apparatus 20 and the diagnosing device 50 will now be described with reference to FIG. 6. The inspection apparatus 20 has a configuration partially described with reference to FIG. 2. Specifically, as described above, the inspection apparatus 20 includes the input operation unit 21 and the display unit 22, which constitute the terminal 20T, and the lighting unit 23, the camera 24, and the sensor 25, which are the image capturing system components described above.

Further, the inspection apparatus 20 includes a first output unit 38 and a first input unit 39, which are connected to the network NW. The output unit 38 outputs at least one (for example, all) of the actual configuration data D1, the actual inspection image V1, the actual inspection result data R1, the standard configuration data D2, and the reference images V2 stored in the first storage unit 32 to the diagnosing device 50 from the first output unit 38 via the network NW whenever the inspection apparatus 20 receives an information request from the diagnosing device 50 or whenever a specified information transmission time is reached. The first output unit 38 outputs instruction data for updating the actual configuration data D1 to the diagnosing device 50. The instruction data is data for instructing to update data in the inspection apparatus 20 to new data created by the diagnosing device 50.

The first input unit 39 is, for example, an input interface connectable to the network NW. The first input unit 39 receives data or notifications transmitted from the diagnosing device 50. The notifications include a notification of a diagnostic result. Specifically, the notifications of the diagnostic result include “normal,” “abnormal,” and “update recommendation,” which means that the system is not abnormal but recommends updating the actual configuration data D1 or the standard images V2. The “Update Recommendation” includes recommendations for updating the actual configuration data D1, the reference images V2, or the standard configuration data D2. When the notification of the update recommendation is received, new data for update is sent together. When receiving a notification of an inspection result, the first input unit 39 outputs the inspection result from the first output unit 38 to the diagnosing device 50 via the network NW.

The first computer 31 includes the first storage unit 32. The first storage unit 32 stores the actual configuration data D1, the actual inspection image V1, the actual inspection result data R1, the standard configuration data D2, and the reference images V2. The first storage unit 32 also stores the inspection app AP and other control programs (not shown).

The first computer 31 includes the control unit 33, the configuration processing unit 35, the inspection processing unit 36, and an update processing unit 37, which are software-based processing function units implemented by executing various programs including the inspection app AP retrieved from the first storage unit 32. In particular, the first computer 31 executes the inspection app AP retrieved from the first storage unit 32, so that the inspection processing unit 36 is implemented as software within the first computer 31.

As described with reference to FIG. 2, the control unit 33 controls the lighting unit 23 and the camera 24 based on the detection signal from the sensor 25. The first computer 31 includes a signal processing unit (not shown), which converts an image signal acquired from the camera 24 into image data, and an image processing unit (not shown), which performs necessary processes (including image processing) on the image data.

In addition, as described with reference to FIG. 2, the configuration processing unit 35 performs the setting process of setting the actual configuration data D1 based on the input value from the input operation unit 21 and an adjustment process of adjusting the actual configuration data D1. The user may adjust the actual configuration data D1 by operating the input operation unit 21 due to deterioration of the lighting unit 23 or the camera 24, a change in environment such as a change in temperature around or inside the inspection apparatus 20, switching of the article 12 to be inspected (for example, a change in type or model number).

When the article 12 is switched, the reference images V2 for testing purposes are also updated to correspond to the new article 12. Then, a test is performed using the reference images V2 (see FIG. 3), which include non-defective article images and defective article images, thereby setting the standard configuration data D2 that satisfies the required inspection accuracy. Then, the configuration processing unit 35 stores the standard configuration data D2 in the first storage unit 32.

Further, as described with reference to FIG. 2, the inspection processing unit 36 is implemented within the first computer 31 by executing the inspection app AP, which is retrieved from the first storage unit 32. The inspection processing unit 36 (inspection app AP) determines whether the article 12 in the actual inspection image V1 is a non-defective article or a defective article by performing a specified process on the actual inspection image V1 based on the standard configuration data D2. The inspection processing unit 36 outputs the inspection result as the actual inspection result R1.

The update processing unit 37 performs a process of updating the actual configuration data D1, the standard configuration data D2, and the reference images V2. The new data D3 and V3 used for the update are downloaded together with the diagnostic result from the diagnosing device 50 when the diagnosing device 50 outputs a diagnostic result recommending an update of the data. The inspection apparatus 20 receives the new data D3 and V3 together with the notification of the diagnostic result from the diagnosing device 50. In this example, the user determines whether to perform an update to the new data D3 and V3 by checking the diagnostic result and the content of the update recommendation information displayed on the display unit 22. If the user selects the update, the user performs an approval operation for the update by operating the input operation unit 21. Then, the update processing unit 37 updates the pre-update data D2 and V2 to new data D3 and V3.

The data to be updated may be only the standard configuration data D2, only the reference images V2, or both of them.

### Diagnosing Device 50

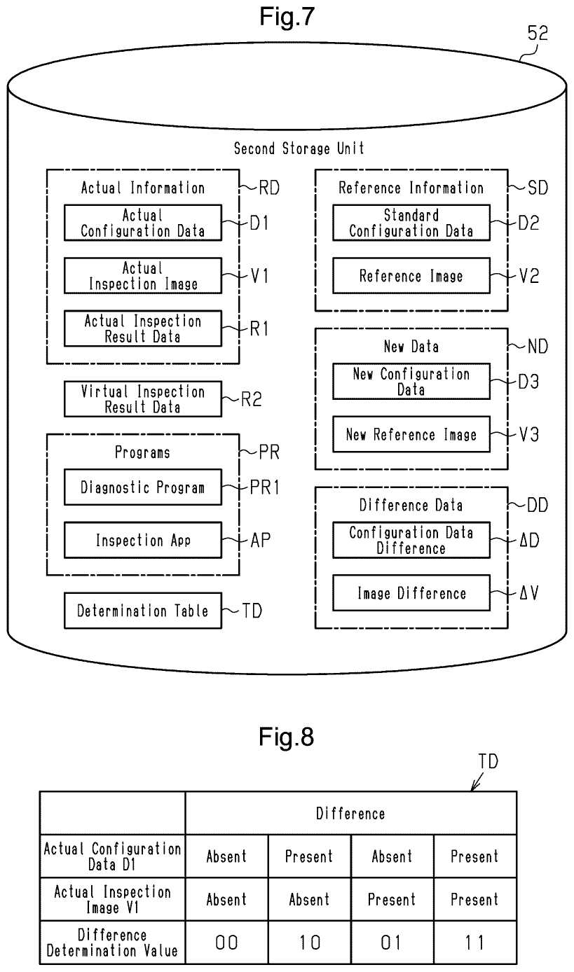

A detailed configuration of the diagnosing device 50 will now be described with reference to FIGS. 6 and 7. The diagnosing device 50 acquires the actual information RD and the reference information SD from the inspection apparatus 20. The diagnosing device 50 then uses the actual information RD and the reference information SD, acquired from the inspection apparatus 20, to diagnose whether the inspection apparatus 20 is performing inspections with the inspection accuracy that should be ensured. The reference information SD is initially acquired as the initial reference information SD. After this initial acquisition, the diagnosing device 50 manages and updates the reference information SD on its own. Accordingly, the diagnosing device 50 does not need to acquire the reference information SD from the inspection apparatus 20 each time a diagnosis is performed.

As illustrated in FIG. 6, the diagnosing device 50 includes the second computer 51, a second input unit 53 as an example of an input unit, and a second output unit 54 as an example of an output unit. The second computer 51 includes the second storage unit 52. That is, the diagnosing device 50 includes the second storage unit 52 as an example of a storage unit.

The second input unit 53 receives various types of data from the inspection apparatus 20 and the terminal 20T via the network NW. The second input unit 53 is, for example, an input interface connectable to the network NW.

The second output unit 54 outputs various notifications and various types of data to the inspection apparatus 20 and the terminal 20T via the network NW. The notifications include a notification of a diagnostic result. Further, the data includes new data ND (see FIG. 7). The new data ND is replacement data that should be used to update the current data when the diagnostic result recommends data updating.

The second storage unit 52 stores programs PR, a determination table TD, and various types of data, including D1, V1, R1, D2, V2, D3, V3, AD, and AV. The programs PR include a diagnostic program PR1 and the inspection app AP.

Specifically, as shown in FIG. 7, the second storage unit 52 stores the programs PR, the determination table TD, the actual information RD, the reference information SD, the new data ND, difference data DD, virtual inspection result data R2, and the like. The actual information RD includes the actual configuration data D1, the actual inspection image V1, and the actual inspection result data R1. The reference information SD includes the standard configuration data D2 and the reference image V2. The new data ND includes new configuration data D3 and new reference images V3. The difference data DD includes data of a configuration data difference AD and an image difference AV. The data stored in the second storage unit 52 includes various types of data acquired from the inspection apparatus 20 for diagnosis.

The second computer 51 executes the programs PR retrieved from the second storage unit 52, thereby including various software-based processing function units.

Specifically, the second computer 51 includes, as software-based processing function units, an information acquisition unit 61, a determination unit 62, a diagnosis processing unit 63, an inspection processing unit 64 (inspection app AP), and a notification unit 65. The diagnosis processing unit 63 includes a difference factor analyzing unit 71 (hereinafter also referred to simply as the factor analyzing unit 71) and a new data generating unit 72.

The second computer 51 includes an inspection processing unit 64, which is software-based and has the same inspection processing functions as the inspection processing unit 36 within the inspection apparatus 20. The inspection processing unit 64 is implemented within the second computer 51 by executing the same inspection app AP used in the inspection apparatus 20, which is retrieved from the second storage unit 52. The inspection processing unit 64 is used for a verification test for verifying whether the new configuration data ensures the required accuracy before providing the new configuration data for the update when the diagnostic result recommends an update to the new data. In addition to the verification test, the inspection processing unit 64 performs extraction of new configuration data, optimization of new configuration data by repeatedly executing inspection simulation using the extracted new configuration data, and the like. Since the inspection app AP is upgraded regularly or irregularly, the diagnosing device 50 acquires the inspection app AP actually used in the inspection apparatus 20 from the inspection apparatus 20. The second computer 51 then executes the acquired inspection app AP, thereby implementing the inspection processing unit 64 within the second computer 51.

The information acquisition unit 61 acquires the actual information RD and the reference information SD from the inspection apparatus 20 at an information acquisition time for diagnosis preparation or a diagnosis time. The actual information RD includes the actual configuration data D1, the actual inspection image V1, and the actual inspection result data R1. The reference information SD includes the standard configuration data D2 and the reference images V2. For example, the information acquisition unit 61 may acquire the reference information SD from the inspection apparatus 20 at an information acquisition time prior to the diagnosis time. In this case, as described above, the information acquisition unit 61 may only acquire the initial reference information SD at the first information acquisition time when the reference information SD is set in the inspection apparatus 20. For example, the information acquisition unit 61 may acquire only the actual information RD from the inspection apparatus 20 at the diagnosis time. In this manner, the acquisition times of the actual information RD and the reference information SD may be the same or different. The actual information RD and the reference information SD are used in the determination process of the determination unit 62. The information acquisition unit 61 stores the acquired actual information RD and reference information SD in the second storage unit 52. The second storage unit 52 stores the actual configuration data D1, the actual inspection image V1, the actual inspection result data R1, the standard configuration data D2, the reference images V2, and the like acquired from the inspection apparatus 20.

The determination unit 62 performs individual comparisons for each of multiple pairs of the actual information RD and the reference information SD, including a first comparison between the actual configuration data D1 and the standard configuration data D2, and a second comparison between the actual inspection image V1 and the reference images V2 for testing purposes. In the present embodiment, the first comparison is a configuration data comparison process of comparing the actual configuration data D1 with the standard configuration data D2. The second comparison is an image comparison process of comparing the actual inspection image V1 with the reference images V2 for testing purposes. The result of the first comparison determines whether there is a difference between the configuration data D1 and the configuration data D2. The result of the second comparison determines whether there is a difference between the images V1 and V2. In this manner, the determination unit 62 determines whether there is a difference between each comparison pair.

In the present embodiment, the determination unit 62 outputs, for example, a determination value of a specified number of bits. This determination value represents a combination of results regarding whether there is a difference. These results are obtained from performing multiple comparisons between the actual information RD and the standard information SD of the same type. For example, the second storage unit 52 stores a determination table TD, as illustrated in FIG. 8. The determination unit 62 references the determination table TD to obtain, as a determination result, the combination result of whether there is a difference in multiple comparison pairs. The determination result is acquired, for example, as a two-bit difference determination value. In the example shown in FIG. 8, whether there is a difference in the first comparison result is represented in the second digit of the two-bit value, while whether there is a difference in the second comparison result is represented in the first digit of the two-bit value.

In the example of the determination table TD shown in FIG. 8, when there is no difference between the configuration data D1 and D2 and no difference between the images V1 and V2, the difference determination value is set to “00.” When there is a difference between the configuration data D1 and D2, but no difference between the images V1 and V2, the difference determination value is set to “10.” Further, when there is no difference between the configuration data D1 and D2, but there is a difference between the images V1 and V2, the difference determination value is set to “01.” When there is a difference between the configuration data D1 and D2, and between the images V1 and V2, the difference determination value is set to “11.” The determination unit 62 transmits the determination result to the diagnosis processing unit 63 as, for example, a two-bit difference determination value.

The diagnosis processing unit 63 performs a diagnostic process. Specifically, the diagnosis processing unit 63 performs factor analysis for analyzing factors according to a combination regarding whether there is a difference in each of the pairs acquired as a determination result, and diagnosis of the inspection apparatus 20 with diagnosis content according to an obtained factor analysis result. The factor analysis is performed by the factor analyzing unit 71.

The new data generating unit 72 generates new data ND in accordance with the factors of the difference analyzed by the factor analyzing unit 71. The new data generating unit 72 creates at least one of the new configuration data D3 and the new reference images V3 according to the factors of the difference. The new configuration data D3 and the new reference images V3, generated by the new data generating unit 72, are stored in the second storage unit 52 as the new data ND.

The diagnosis processing unit 63 applies the new data ND to the inspection processing unit 64 (inspection app AP) to perform a virtual inspection test. Specifically, the diagnosis processing unit 63 causes the inspection processing unit 64 to perform an inspection process using the new data ND. Since this inspection process utilizes the same inspection app AP as the inspection processing unit 36 in the inspection apparatus 20, the diagnosing device 50 performs the virtual inspection with the same inspection content as that conducted by the inspection apparatus 20.

### Operation

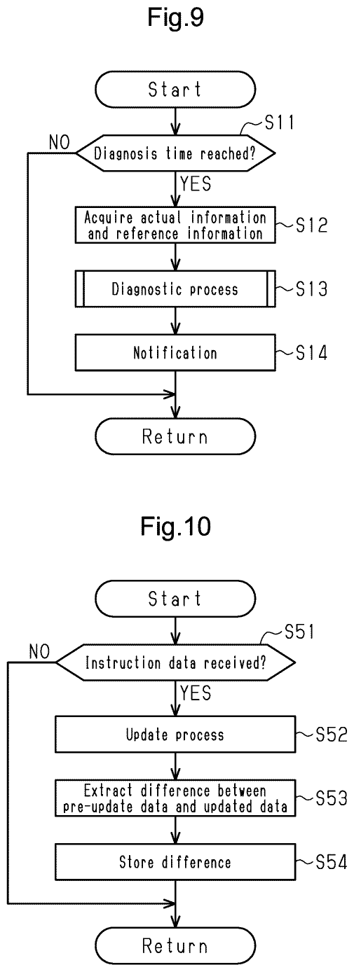

Next, operation of the diagnosing device 50 will be described with reference to FIGS. 9 to 11.

The CPU of the second computer 51 (hereinafter, also simply referred to as a computer 51) executes the programs PR. The programs PR cause the computer 51 to perform a process for diagnosing the inspection apparatus 20 based on the actual information RD and the reference information SD acquired from the inspection apparatus 20.

First, a diagnosis main routine will be described with reference to FIG. 9.

In FIG. 9, first, at step S11, it is determined whether the diagnosis time is reached. If the diagnostic time is reached, the process proceeds to step S12, and the diagnostic time has not been reached, the process ends.

At step S12, the computer 51 acquires the actual information RD and the reference information SD. The computer 51 acquires the actual information RD from the inspection apparatus 20 via the network NW. Since the reference information SD is already stored in the second storage unit 52 for each article number of the article 12 to be inspected, the computer 51 acquires the reference information SD by retrieving the reference information SD from the second storage unit 52. The actual configuration data D1 and the actual inspection image V1 are acquired as the actual information RD. In addition, the standard configuration data D2 and the reference images V2 are acquired as the reference information SD. Further, the actual inspection result data R1 may be acquired as the actual information RD. The reference information SD may be acquired from the inspection apparatus 20 via the network NW when there is no data or an abnormality. The process of step S11 corresponds to an example of an information acquisition step of acquiring the actual configuration data D1 and the actual inspection image V1 as the actual information RD from the inspection apparatus 20.

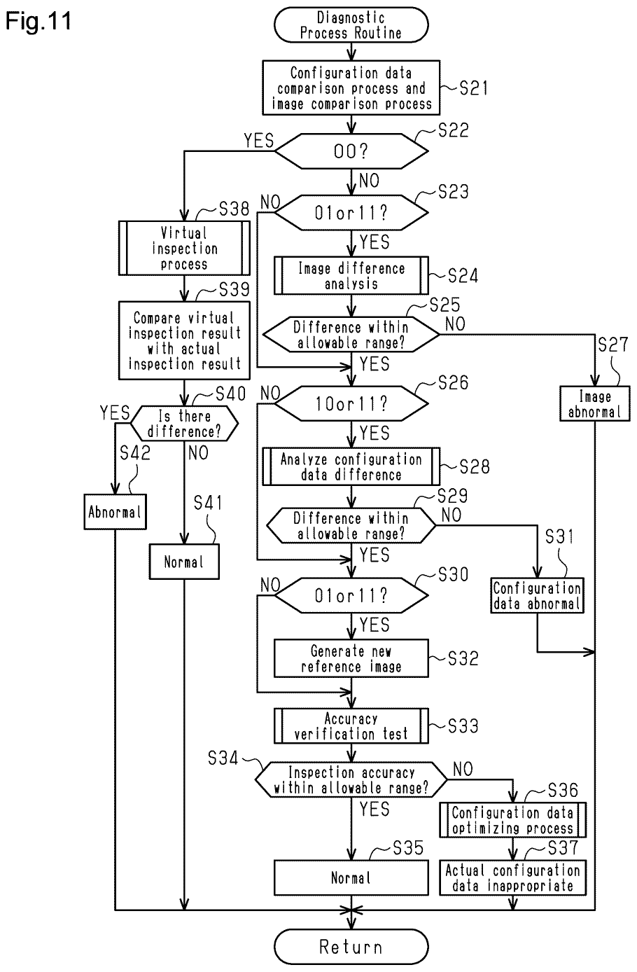

At the next step S13, the computer 51 executes the diagnostic process. The details of this diagnostic process will be described later with reference to the diagnostic process routine of FIG. 11. In the diagnostic process, the inspection apparatus 20 is diagnosed based on the actual information RD and the reference information SD acquired from the inspection apparatus 20. The diagnostic results include classifications such as “normal,” “abnormal,” “configuration data abnormal,” “actual configuration data inappropriate,” and “image abnormal.”

At the next step S14, the computer 51 transmits a notification of the diagnostic result. Specifically, when the diagnostic result is “normal,” the computer 51 notifies the inspection apparatus 20 or the terminals 20T that the system is operating normally. If the diagnostic result is “inappropriate configuration data,” the computer 51 notifies the inspection apparatus 20 or the terminal 20T that the configuration data is inappropriate and prompts an update of the actual configuration data D1. In this case, the computer 51 transmits the configuration data D3 for update to the inspection apparatus 20 or the terminals 20T to update the actual configuration data D1 (or the standard configuration data D2).

When the diagnostic result is “reference image inappropriate,” the computer 51 notifies the inspection apparatus 20 or the terminals 20T that the reference image is inappropriate and prompts the inspection apparatus 20 or the terminal 20T to update the reference images V2. At this time, the computer 51 transmits new reference images V3 to the inspection apparatus 20 or the terminal 20T to update the reference images V2. Additionally, if the diagnostic result is “abnormal,” the computer 51 notifies the inspection apparatus 20 or the terminal 20T to check the factors of the abnormal determination and prompts the suspension of the operation of the inspection apparatus 20.

### Diagnostic Process Routine

Next, the diagnostic process routine will be described with reference to FIG. 11.

First, at step S21, the computer 51 executes a configuration data comparison process and an image comparison process. Specifically, as the configuration data comparison process, the computer 51 compares the actual configuration data D1 and the standard configuration data D2 to acquire a difference (change). In addition, the computer 51 acquires a difference by comparing the actual inspection image V1 and the reference images V2 as the image comparison process. In the present embodiment, the process of step S21 corresponds to an example of a determination step.

The computer 51 performs individual comparisons, including the first comparison for the configuration data comparison process and the second comparison for the image comparison process. These comparisons are conducted between the actual information RD and the reference information SD of the same type. Accordingly, the computer 51 determines whether there is a difference between each comparison pair.

Specifically, the type of one pair of data sets to be compared is “configuration data.” The computer 51 compares the actual information RD (actual configuration data D1) and the reference information SD (standard configuration data D2) of the configuration data to determine whether there is a difference between the configuration data. That is, through the first comparison, the computer 51 determines whether the actual configuration data D1 has been modified from the standard configuration data D2.

Another type of data in a comparison pair is “inspection images.” The computer 51 compares the actual information RD (actual inspection image V1) with the reference information SD (reference images V2) to determine whether there is a difference in the inspection images. That is, through the second comparison, the computer 51 determines whether the actual inspection image V1 differs from the reference image V2.

At step S22, the computer 51 determines whether the difference determination value is “00.” The computer 51 proceeds to step S38 if the difference determination value is “00,” and proceeds to step S23 if the difference determination value is not “00.” That is, if there are no changes in the actual configuration data D1 and no difference in the actual inspection image V1 (difference determination value=“00”), the process proceeds to step S38. On the other hand, if there are changes in the actual configuration data D1 or a difference in the actual inspection image V1 (difference determination value=“00”), the process proceeds to step S23.

At step S23, the computer 51 determines whether the difference determination value is “01” or “11.” The computer 51 proceeds to step S24 if the difference determination value is “01” or “11,” and proceeds to step S26 if the difference determination value is neither “01” nor “11” (i.e., “10”).

At step S24, the computer 51 performs image difference analysis. The image difference analysis is a process of analyzing portions of image that have a difference. In the image difference analysis, image difference factor extraction for extracting factors based on the difference obtained by the analysis may be performed together. The extracted factors from the image difference factor extraction are used in the subsequent determination step to establish an allowable range.

At step S25, the computer 51 determines whether a difference is within the allowable range. Specifically, the computer 51 determines whether an image difference is within the allowable range, which is individually set for each factor of the difference. If the difference is within the allowable range, the process proceeds to step S26, and if the difference is not within the allowable range, the process proceeds to step S27.

At step S27, the computer 51 determines the diagnostic result to be “image abnormal.”

At step S26, the computer 51 determines whether the difference determination value is “10” or “11.” The computer 51 proceeds to step S28 if the difference determination value is “10” or “11,” and proceeds to step S30 if the difference determination value is neither “10” nor “11” (i.e., “01”).

At step S28, the computer 51 performs configuration data difference analysis. The configuration data difference analysis is a process of analyzing a different (changed) parameter among multiple parameters included in the actual configuration data D1 and the amount of the difference (change amount). When there are multiple different parameters, a combination of different parameters may be analyzed. In the configuration data difference analysis, configuration difference factor extraction for extracting factors based on the difference obtained by the analysis may be performed together. The extracted factors from the configuration data difference factor extraction are used in the subsequent determination step to establish an allowable range.

At the subsequent step S29, the computer 51 determines whether the difference is within an allowable range. Specifically, the computer 51 determines whether the configuration data difference is within an allowable range individually set for each factor of the difference. For example, the computer 51 references table data that associates factors with allowable ranges to acquire an allowable range corresponding to the factors. If the difference is within the allowable range, the computer 51 proceeds to step S30, and if the difference is not within the allowable range, the computer 51 proceeds to step S31.

At step S31, the computer 51 determines the diagnosis result to be “configuration data abnormal.”At step S30, the computer 51 determines whether the difference determination value is “01” or “11.” The computer 51 proceeds to step S32 if the difference determination value is “01” or “11,” and proceeds to step S33 if the difference determination value is neither “01” nor “11” (i.e., “10”).

At step S32, the computer 51 generates a new reference image based on the image difference factors. This process is performed by the new data generating unit 72. The new data generating unit 72 generates new reference images V3 by modifying the reference images V2 based on the image difference factors.

At the next step S33, the computer 51 executes an accuracy verification test. This process is performed by the inspection processing unit 64 (inspection app AP). In this accuracy verification process, a virtual inspection is conducted based on the inspection app AP to verify whether the inspection accuracy is ensured. The configuration data and the reference image applied to the virtual inspection are different depending on the difference determination value.

Specifically, when the difference determination value is “10,” there is a difference only in the configuration data. In this case, the accuracy verification process determines whether the inspection accuracy remains ensured despite the presence of the difference.

Since there is no difference between the actual inspection image V1 and the reference images V2, the inspection results are generated using the reference images V2.

On the other hand, when the difference determination value is “01” or “11,” there is a difference between the actual inspection image V1 and the reference images V2. In this case, a virtual inspection is conducted to verify whether the inspection accuracy remains ensured despite the presence of the image difference. Since there is a difference between the actual inspection image V1 and the reference images V2, the new reference images V3 are first generated (S32) to eliminate or reduce this difference. Then, in this step, the computer 51 performs the virtual inspection by executing the inspection app AP using the actual configuration data D1 and the new reference image V3. The accuracy verification is performed based on the result of this virtual inspection. That is, the computer 51 verifies whether updating the reference image to the new reference image V3 ensures the inspection accuracy by conducting the virtual inspection using the new reference image V3 and analyzing the inspection result.

The image difference analysis is performed before the configuration data difference analysis to prevent misdiagnosis of a configuration data abnormality. If the configuration data difference analysis were performed without first confirming that the reference images V2 is appropriate, an erroneous determination of a configuration data abnormality could occur. In the present embodiment, when the difference determination value is “11,” the computer 51 processes the image difference analysis (S24) before the configuration data difference analysis (S28). By first eliminating image abnormalities (S27) and then diagnosing the actual configuration data D1, the system ensures that configuration data abnormality is correctly diagnosed.

At step S34, the computer 51 determines whether the inspection accuracy is within an allowable range. If the inspection accuracy is within the allowable range, the computer 51 proceeds to step S35, and if the inspection accuracy is not within the allowable range, the computer 51 proceeds to step S36.

At step S35, the computer 51 determines the diagnostic result to be “normal.” At step S36, the computer 51 executes a configuration data optimizing process. This process is performed by the new data generating unit 72. The new data generating unit 72 generates new configuration data D3 by modifying the actual configuration data D1 based on the configuration data difference factors.

At step S37, the computer 51 determines the diagnostic result to be “actual configuration data inappropriate.” In the case of “actual configuration data inappropriate,” updating to the new configuration data D3 is recommended.

On the other hand, if the difference determination value is “00,” the computer 51 executes the processes from step S38 to step S42.

At step S38, the computer 51 executes a virtual inspection process.

At the next step S39, the computer 51 compares the virtual inspection result with the actual inspection result.

At step S40, the computer 51 determines whether there is a difference. If there is no difference, the process proceeds to step S41, and if there is a difference, the process proceeds to step S42.

At step S41, the computer 51 determines the diagnostic result to be “normal.”

At step S42, the computer 51 determines the diagnostic result to be “abnormal.”

In the present embodiment, as shown in FIG. 11, the processes performed in steps S24, S25, S27 to S29, and S31 to S42 correspond to examples of diagnosis processing steps. These steps determine the diagnosis content based on the combination of whether there is a difference in the respective comparison pairs (the difference determination values “00,” “10,” “01,” and “11”), which is obtained as the determination result.

Thus, when the difference determination value is “01,” in other words, when the determination result of the determination unit 62 indicates that there is no difference in the first comparison, but there is a difference in the second comparison, the diagnosis processing unit 63 performs a diagnosis for analyzing the image difference factors. If the image difference falls within the allowable range, the diagnosis processing unit 63 generates a new reference image V3 by modifying the reference image V2 based on the difference analysis result. Furthermore, the diagnosis processing unit 63 conducts an inspection accuracy test using the actual configuration data D1 and the new reference image V3. If the accuracy result is insufficient, the diagnosis processing unit 63 generates new configuration data D3 for improving the inspection accuracy.

When the difference determination value is “10,” in other words, when the determination result of the determination unit 62 indicates that there is a difference in the first comparison but there is no difference in the second comparison, the diagnosis processing unit 63 performs a diagnosis for analyzing the configuration data difference factors. If the configuration data difference is within the allowable range, the diagnosis processing unit 63 performs the inspection accuracy test using the actual configuration data D1 and the reference images V2 based on the difference analysis result. When the accuracy result is insufficient, the diagnosis processing unit 63 generates new configuration data D3 for improving the inspection accuracy.

Further, when the difference determination value is “11,” in other words, when the determination result of the determination unit 62 indicates that there is a difference in the first comparison, and there is a difference in the second comparison, the diagnosis processing unit 63 performs a diagnosis for analyzing the image difference factors. When the image difference is within the allowable range, the diagnosis processing unit 63 performs a diagnosis for analyzing configuration data difference factors. Furthermore, if the configuration difference falls within the allowable range, the diagnosis processing unit 63 generates a new reference image V3 by modifying the reference image V2 based on the image difference analysis result. The diagnosis processing unit 63 conducts an inspection accuracy test using the actual configuration data D1 and the new reference image V3. If the accuracy result is insufficient, the diagnosis processing unit 63 generates new configuration data D3 for improving the inspection accuracy.

When the difference determination value is “00,” in other words, when the determination result of the determination unit 62 indicates that there is no difference in either the first comparison or the second comparison, the diagnosis processing unit 63 performs an inspection (virtual inspection) using the actual configuration data D1 and the actual inspection image V1. Then, the diagnosis processing unit 63 uses the actual inspection result data R1 and the virtual inspection result data R2 to perform comparison diagnosis between the virtual inspection result and the actual inspection result. When there is a difference in the comparison diagnosis, it is estimated, for example, that there is an abnormality such as an inappropriate version of the inspection app AP (inspection processing software).

New Data Updating Process Next, a new data updating process will be described. When a user views the diagnostic result on the display unit 22 of the inspection apparatus 20 or the terminal 20T, and the diagnostic result indicates “actual configuration data inappropriate” or “image abnormal,” an update to new data is recommended. If the user wishes to proceed with the update to new data, the user operates the input operation unit 21 to issue an instruction to update to new data. The instruction data is then transmitted from the inspection apparatus 20 or the terminal 20T to the diagnosing device 50 via the network NW. Meanwhile, after transmitting the diagnostic result at step S14 in FIG. 9, the second computer 51 of the diagnosing device 50 starts an updating process routine shown in FIG. 10 and waits to receive the instruction data from the inspection apparatus 20 or the terminal 20T.

Hereinafter, the updating process routine executed by the second computer 51 will be described with reference to FIG. 10.

At step S51, the computer 51 determines whether the instruction data has been received. If the computer 51 receives the instruction data, the computer 51 proceeds to step S52. If the computer 51 does not receive the instruction data, the computer 51 terminates the routine. If the computer 51 does not receive instruction data after waiting for a predetermined period following the notification of the diagnostic result, or if the computer 51 receives data indicating that a new data update is not required, the computer 51 determines that no instruction data has been received.

At step S52, the computer 51 executes the updating process. Specifically, the computer 51 accesses the inspection apparatus 20 and updates the pre-update data to new data ND. If the new data ND is the new configuration data D3, the computer 51 updates the standard configuration data D2 within the inspection apparatus 20 to the new configuration data D3. If the new data ND is a new reference image V3, the computer 51 updates the reference images V2 in the inspection apparatus 20 to the new reference image V3.

Additionally, the computer 51 accesses the second storage unit 52 and performs an updating process to update the pre-update data to the new data ND. Specifically, the computer 51 performs the same updating process for the data in the second storage unit 52 as it did for the inspection apparatus 20 to replace the pre-update data with the new data ND. Through this process, the updated data remains consistent between the inspection apparatus 20 and the diagnosing device 50.

At the subsequent step S53, the computer 51 extracts the difference between data before and after the update. That is, the computer 51 extracts the difference between the pre-update data and the new data ND. Specifically, if the new data ND is the new configuration data D3, the computer 51 extracts the configuration data difference AD, which is the difference between the pre-update standard configuration data D2 and the new configuration data D3. If the new data ND is the new reference image V3, the computer 51 extracts the image difference AV, which is the difference between the pre-update reference image V2 and the new reference image V3.

At the next step S54, the computer 51 stores the difference. In other words, the computer 51 stores, in the second storage unit 52, at least one of the configuration data difference AD and the image difference AV, which has been extracted at step S53. The computer 51 may store at least one of the configuration data difference AD and the image difference AV in the first storage unit 32 in the inspection apparatus 20.

### ADVANTAGES OF THE EMBODIMENT

The embodiment described above has the following advantages.

(1) The diagnosing device 50 diagnoses the inspection apparatus 20 based on the actual information RD acquired from the inspection apparatus 20. The diagnosing device 50 includes the information acquisition unit 61, the storage unit 52, the determination unit 62, and the diagnosis processing unit 63. The information acquisition unit 61 acquires the actual configuration data D1 and the actual inspection image V1 as the actual information RD from the inspection apparatus 20. The storage unit 52 stores the standard configuration data D2 and the reference images V2 as the reference information SD. The determination unit 62 performs individual comparisons for each of multiple pairs of the actual information RD and the reference information SD, including the first comparison between the actual configuration data D1 and the standard configuration data D2, and the second comparison between the actual inspection image V1 and the reference image V2, to determine whether there is a difference in each comparison pair of the same type. The diagnosis processing unit 63 performs the factor analysis for analyzing factors according to a combination regarding whether there is a difference in each of the pairs acquired as a determination result. The diagnosis processing unit 63 then performs diagnosis of the inspection apparatus 20 with diagnosis content according to an obtained factor analysis result. With this configuration, it is possible to diagnose whether the inspection apparatus 20 is performing inspections properly. For example, inappropriate inspection conditions are detected at an early stage and reported, allowing for more frequent optimization of the inspection conditions.

(2) When the determination result of the determination unit 62 indicates that there is no difference in the first comparison but there is a difference in the second comparison, the diagnosis processing unit 63 performs a diagnosis for analyzing the image difference factors. If the image difference falls within the allowable range, the diagnosis processing unit 63 generates a new reference image V3 by modifying the reference image V2 based on the difference analysis result. Furthermore, the diagnosis processing unit 63 conducts an inspection accuracy test using the actual configuration data D1 and the new reference image V3. If the accuracy result is insufficient, the diagnosis processing unit 63 generates new configuration data D3 for improving the inspection accuracy. With this configuration, if the inspection apparatus 20 is unable to perform inspections with the required accuracy due to inspection images, the new configuration data D3 that improves inspection accuracy is provided.

(3) When the determination result of the determination unit 62 indicates that there is a difference in the first comparison, but there is no difference in the second comparison, the diagnosis processing unit 63 performs a diagnosis for analyzing the configuration data difference factors. If the configuration data difference is within the allowable range, the diagnosis processing unit 63 performs the inspection accuracy test using the actual configuration data D1 and the reference images V2 based on the difference analysis result. When the accuracy result is insufficient, the diagnosis processing unit 63 generates new configuration data D3 for improving the inspection accuracy. With this configuration, if the inspection apparatus 20 is unable to perform inspections with the required accuracy due to configuration data, new configuration data D3 that improves the inspection accuracy is provided.

(4) When the determination result of the determination unit 62 indicates that there is a difference in the first comparison, and there is a difference in the second comparison, the diagnosis processing unit 63 performs a diagnosis for analyzing the image difference factors. When the image difference is within the allowable range, the diagnosis processing unit 63 performs a diagnosis for analyzing configuration data difference factors. Furthermore, if the configuration difference falls within the allowable range, the diagnosis processing unit 63 generates a new reference image V3 by modifying the reference image V2 based on the image difference analysis result. The diagnosis processing unit 63 conducts an inspection accuracy test using the actual configuration data D1 and the new reference image V3. If the accuracy result is insufficient, the diagnosis processing unit 63 generates new configuration data D3 for improving the inspection accuracy. With this configuration, if the inspection apparatus 20 is unable to perform inspections with the required accuracy due to configuration data and inspection images, new configuration data D3 that improves the inspection accuracy is provided.

(5) The diagnosing device 50 includes the output unit 54 for outputting data and the input unit 53 for receiving instructions. The diagnosis processing unit 63 outputs the new configuration data D3 from the output unit 54. Upon receiving an instruction from the input unit 53 to adopt the new configuration data D3, the diagnosis processing unit 63 updates the standard configuration data D2 and the reference images V2 based on the new configuration data D3. With this configuration, the standard configuration data D2 and the reference images V2 are updated based on the adopted new configuration data D3, enabling the inspection apparatus 20 to perform subsequent inspections properly.

(6) The diagnosing device 50 stores, in the storage unit 52, the standard configuration data D2 and the reference images V2 before the standard configuration data D2 and the reference images V2 are updated based on the new configuration data D3.

Furthermore, the diagnosing device 50 stores, in the storage unit 52, the difference AD, AV between the pre-update data and the updated new data D3, V3 for at least one of the standard configuration data D2 and the reference images V2 that has been updated.

With this configuration, the history of the diagnosing device 50 can be checked by retrieving, from the storage unit 52, at least one of the pre-update standard configuration data D2, the pre-update reference image V2, and the difference AD, AV between the pre-update data and the updated data. For example, the history information can be used for recovery or analysis and can further serve to restrict the escalation of a difference in the configuration data and the reference images V2 among multiple identical inspection apparatuses 20.

(7) The actual inspection result R1 is acquired as the actual information RD from the inspection apparatus 20. When the determination result of the determination unit 62 indicates that there is no difference in either the first comparison or the second comparison, the diagnosis processing unit 63 performs the virtual inspection using the actual configuration data D1 and the actual inspection image V1. Then, the diagnosis processing unit 63 performs comparison diagnosis between the virtual inspection result and the actual inspection result. With this configuration, when neither the configuration data nor the inspection images are the cause, but there is a difference between the virtual inspection result and the actual inspection result, it is possible to diagnose that the inspection process itself is inappropriate. For example, it is possible to diagnose that the version of the inspection processing software is inappropriate.

(8) The diagnosing device 50 includes the server 50S connected to the inspection apparatus 20 and the terminal 20T via the network NW. The server 50S includes the information acquisition unit 61, the storage unit 52, the determination unit 62, and the diagnosis processing unit 63. The server 50S acquires the actual configuration data D1 and the actual inspection image V1 from the inspection apparatus 20, and transmits the diagnostic result of the diagnosis processing unit 63 to the terminal 20T. With this configuration, the diagnosis of the inspection apparatus 20 can be performed via the network NW, and the diagnostic result can be checked on the terminal 20T via the network NW.

(9) The method for diagnosing the inspection apparatus 20 based on the actual information RD acquired from the inspection apparatus 20 includes an information acquisition step, a determination step, and a diagnosis processing step. In the information acquisition step, the information acquisition unit 61 acquires the actual configuration data D1 and the actual inspection image V1 as the actual information RD from the inspection apparatus 20. At the determination step, the determination unit 62 performs individual comparisons for each of multiple pairs of the actual information RD and the reference information SD, including the first comparison between the actual configuration data D1 and the standard configuration data D2, and the second comparison between the actual inspection image V1 and the reference image V2, to determine whether there is a difference in each comparison pair of the same type. In the diagnosis processing step, the diagnosis processing unit 63 performs diagnosis with diagnosis content according to a combination regarding whether there is a difference in each of the pairs acquired as determination results. With this method, it is possible to diagnose whether the inspection apparatus 20 is performing inspections properly.

(10) The programs PR cause a computer to diagnose the inspection apparatus 20 based on the actual information RD acquired from the inspection apparatus 20. The programs PR cause the computer to execute the information acquisition step, the determination step, and the diagnosis processing step. In the information acquisition step, the actual configuration data D1 and the actual inspection image V1 are acquired as the actual information RD from the inspection apparatus 20. In the determination step, individual comparisons for each of multiple pairs of the actual information RD and the reference information SD are performed, including the first comparison between the actual configuration data D1 and the standard configuration data D2, and the second comparison between the actual inspection image V1 and the reference images V2, to determine whether there is a difference in each comparison pair of the same type. In the diagnosis processing step, diagnosis is performed with diagnosis content according to a combination regarding whether there is a difference in each of the pairs acquired as a determination result. When executed by the computer 51, the programs PR allows for diagnosis of whether the inspection apparatus 20 is performing inspections properly.

The disclosed embodiment is not limited to the above and may be modified in the following manners.

The diagnosing device 50 is not limited to a server. In this case, the inspection apparatus 20 and the diagnosing device 50 may be connected via a LAN. For example, multiple inspection apparatuses 20 in a factory may be connected to one common diagnosing device 50 via the factory LAN. Moreover, the diagnosing device 50 may be incorporated into the terminal 20T. Further, the diagnosing device 50 may be incorporated in the inspection apparatus 20. In this case, the first computer 31 of the inspection apparatus 20 and the second computer 51 of the diagnosing device 50 may be separate computers, or may be a single computer shared by the inspection apparatus 20 and the diagnosing device 50.

The terminal 20T may be incorporated in the inspection apparatus 20 or may be communicatively connected to the inspection apparatus 20 via a LAN.

An automatic update mode may be set in advance from the inspection apparatus 20 or the corresponding terminal 20T. In this case, in the automatic update mode, inappropriate configuration data D1 or an inappropriate actual inspection image V1 may be automatically updated to new data.

The new data recommended for update may be transmitted along with the determination result to the user's inspection apparatus 20 or terminal 20T, and the decision to update to the new data may be left to the user.

The diagnosing device 50 may be configured to accept diagnostic instructions from the inspection apparatus 20 or the terminal 20T. Upon receiving such instructions, the diagnosing device 50 may perform diagnostic process and transmit the diagnostic result to the inspection apparatus 20 or the terminal 20T. For example, when the actual configuration data D1 is adjusted, the diagnosing device 50 can be used to check whether the adjustment ensures the required accuracy.

The individual comparisons performed for each of multiple pairs of the actual information RD and the reference information SD of the same type are not limited to the two comparisons: the first comparison and the second comparison. For example, three comparisons may be provided by adding a third comparison, or four comparisons may be provided by further adding a fourth comparison. For example, the determination unit 62 may perform a third comparison by comparing the actual inspection result data R1 with the inspection result data R2 during testing to determine whether there is a difference between them.

The determination unit 62 does not necessarily need to perform the factor analysis on all of the multiple combinations obtained by determining whether there is a difference in each pair to be compared, and may only perform the factor analysis on at least one combination. For example, in the above-described embodiment, the processes of steps S37 to S40 in FIG. 11 may be omitted.

In the above-described embodiment, the diagnosing device 50 may be configured to transmit only a diagnostic result indicating whether the inspection apparatus 20 or the terminal 20T is in a normal or abnormal state.

In the above-described embodiment, the diagnosing device 50 transmits a diagnostic result indicating whether the status is normal, abnormal, or inappropriate to the inspection apparatus 20 or the terminal 20T. However, the system may be configured not to generate new data recommended for updates. In this case, the decision regarding whether to perform an update and the content of the update may be left to the user.

The programs PR may be sold in a state of being stored in a storage medium such as a CD or a DVD.

The inspection object of the inspection apparatus 20 to be diagnosed by the diagnosing device 50 is not particularly limited. The article 12 to be inspected is not limited to a container or the like. The inspection object may include various components such as electronic components and mechanical parts, various articles such as electrical appliances and mechanical products, or even processed items conveyed along a manufacturing line that produces such products. Further, the inspection may be an acceptance inspection of components or a pre-shipment inspection of a component or products. The inspection performed by the inspection apparatus 20 may be a non-destructive inspection using X-rays, ultrasonic waves, or the like.

REFERENCE SIGNS LIST

10) Inspection System; 11) Conveying Apparatus; 12) Article; 12A) Container Body; 12B) Label; 13) Conveying Apparatus; 14) Conveyor; 15) Contour Line; 20) Inspection Apparatus; 20T) Terminal; 21) Input Operation Unit; 22) Display Unit; 23) Lighting Unit; 24) Camera; 25) Sensor; 31) First Computer; 32) First Storage Unit; 33) Control Unit; 35) Configuration Processing Unit; 36) Inspection Processing Unit; 37) Update Processing Unit; 38) First Output Unit; 39) First Input Unit; 50) Diagnosing Device; 50S) Server (Cloud Server); 51) Second Computer; 52) Second Storage Unit as an Example of Storage Unit; 53) Second Input Unit as an Example of Input Unit; 54) Second Output Unit as an Example of Output Unit; 61) Information Acquisition Unit; 62) Determination Unit; 63) Diagnosis Processing Unit; 64) Inspection Processing Unit (Inspection App); 65) Notification Unit; 71) Factor Analyzing Unit (Difference Factor Analyzing Unit); 72) Inspection Processing Unit; NW) Network; AP) Inspection Application (Inspection App); PR) Programs; PR1) Diagnostic Program; GV) Non-Defective Article Images; NV) Defective Article Image; F) Defect; F1) Stain; F2) Tear; FN) Appropriate Defect Region; FL) Excessively Large Defect Region; FS) Excessively Small Defect Region; TD) Determination Table; RD) Real Information; SD) Reference Information; D1) Actual Configural Data; V1) Actual Inspection Image; R1) Actual Inspection Result Data; D2) Standard Configuration Data; V2) Reference Images for Testing Purposes; R2) Virtual Inspection Result Data; ND) New Data; D3) New Configuration Data as Example of New Data; V3) New Reference Image as New Data; DD) Difference Data; AD) Difference (Configuration Data Difference); AV) Difference (Image Difference).

1. A diagnosing device for an inspection apparatus, the diagnosing device diagnosing the inspection apparatus based on actual information acquired from the inspection apparatus, the diagnosing device-being-e prising:
an information acquisition unit that acquires, as the actual information, actual configuration data and an actual inspection image from the inspection apparatus;
a storage unit that stores, as reference information, standard configuration data and a reference image;
a determination unit that performs individual comparisons for each of multiple pairs of the actual information and the reference information, including a first comparison between the actual configuration data and the standard configuration data, and a second comparison between the actual inspection image and the reference image, to determine whether there is a difference in each comparison pair of a same type; and
a diagnosis processing unit that performs factor analysis for analyzing a factor of the difference according to a combination regarding whether there is the difference in each of the pairs acquired as a determination result, the diagnosis processing unit performing diagnosis of the inspection apparatus with diagnosis content according to an obtained factor analysis result.

2. The diagnosing device for the inspection apparatus according to claim 1, wherein
when the determination result of the determination unit indicates that there is no difference in the first comparison and there is a difference in the second comparison, the diagnosis processing unit performs diagnosis for analyzing an image difference factor,
when an image difference is within an allowable range, the diagnosis processing unit generates a new reference image by modifying the reference image based on a difference analysis result, and performs an inspection accuracy test using the actual configuration data and the new reference image, and
when an accuracy result is insufficient, the diagnosis processing unit generates new configuration data for improving inspection accuracy.

3. The diagnosing device for the inspection apparatus according to claim 1, wherein
when the determination result of the determination unit indicates that there is a difference in the first comparison and there is no difference in the second comparison, the diagnosis processing unit performs diagnosis for analyzing a configuration data difference factor,
when a configuration data difference is within an allowable range, the diagnosis processing unit performs an inspection accuracy test using the actual configuration data and the reference image based on a difference analysis result, and
when an accuracy result is insufficient, the diagnosis processing unit generates new configuration data for improving inspection accuracy.

4. The diagnosing device for the inspection apparatus according to claim 1, wherein
when the determination result of the determination unit indicates that there is a difference in the first comparison and there is a difference in the second comparison, the diagnosis processing unit performs diagnosis for analyzing an image difference factor,
when an image difference is within an allowable range, the diagnosis processing unit performs diagnosis for analyzing a configuration data difference factor,
when a configuration data difference is within an allowable range, the diagnosis processing unit generates a new reference image by modifying the reference image based on an image difference analysis result, and performs an inspection accuracy test using the actual configuration data and the new reference image, and
when an accuracy result is insufficient, the diagnosis processing unit generates new configuration data for improving inspection accuracy.

5. The diagnosing device for the inspection apparatus according to claim 2, the diagnosing device further comprising:
an output unit that outputs data; and
an input unit that receives instructions, wherein
the diagnosis processing unit outputs the new configuration data to the output unit, and when receiving an instruction to adopt the new configuration data from the input unit, updates the standard configuration data and the reference image based on the new configuration data.

6. The diagnosing device for the inspection apparatus according to claim 5, the diagnosing device is configured to:
store, in the storage unit, the standard configuration data and the reference image before the standard configuration data and the reference image are updated based on the new configuration data, and
store, in the storage unit, a difference between pre-update data and updated new data for at least one of the standard configuration data and the reference image that has been updated.

7. The diagnosing device for the inspection apparatus according to claim 2, the diagnosing device is configured to:
acquire an actual inspection result as the actual information from the inspection apparatus,
wherein, when the determination result of the determination unit indicates that there is no difference in the first comparison and there is no difference in the second comparison, the diagnosis processing unit performs a virtual inspection using the actual configuration data and the actual inspection image, and performs a comparison diagnosis between a virtual inspection result and the actual inspection result.

8. The diagnosing device for the inspection apparatus according to claim 1, the diagnosing deyice further comprising a server connected to the inspection apparatus and a terminal via a network,
wherein the server includes the information acquisition unit, the storage unit, the determination unit, and the diagnosis processing unit,
acquires the actual configuration data and the actual inspection image from the inspection apparatus, and
transmits a diagnostic result of the diagnosis processing unit to the terminal.

9. The diagnosing device for the inspection apparatus according to claim 5, the diagnosing deyice further comprising a server connected to the inspection apparatus and a terminal via a network,
wherein the server includes the information acquisition unit, the storage unit, the determination unit, and the diagnosis processing unit,
acquires the actual configuration data and the actual inspection image from the inspection apparatus, and
transmits a diagnostic result of the diagnosis processing unit to the terminal.

10. A diagnosing method for an inspection apparatus, the diagnosing method comprising diagnosing the inspection apparatus based on actual information acquired from the inspection apparatus, the diagnosing method comprising:
an information acquisition step in which an information acquisition unit acquires actual configuration data and an actual inspection image as the actual information from the inspection apparatus;
a determination step in which a determination unit performs individual comparisons for each of multiple pairs of the actual information and reference information, including a first comparison between the actual configuration data and standard configuration data, and a second comparison between the actual inspection image and a reference image, to determine whether there is a difference in each comparison pair of a same type; and
a diagnosis processing step in which a diagnosis processing unit performs diagnosis with diagnosis content according to a combination regarding whether there is the difference in each of the pairs acquired as a determination result.

11. A non-transitory computer-readable storage medium storing a program that causes a computer to execute a process of diagnosing an inspection apparatus based on actual information acquired from the inspection apparatus,
CPU causing the program to execute:
an information acquisition step that acquires actual configuration data and an actual inspection image as the actual information from the inspection apparatus;
a determination step that performs individual comparisons for each of multiple pairs of the actual information and reference information, including a first comparison between the actual configuration data and standard configuration data, and a second comparison between the actual inspection image and a reference image, to determine whether there is a difference in each comparison pair of a same type; and
a diagnosis processing step that performs diagnosis with diagnosis content according to a combination regarding whether there is the difference in each of the pairs acquired as a determination result.
